(19) United States
(12) Patent Application Publication
(10) Pub. No.: US 2016/0329638 A1
(43) Pub. Date: Nov. 10, 2016

(54) NON-CONTACT COMMUNICATION DEVICE AND ANTENNA RESONANCE FREQUENCY CONTROL METHOD

(71) Applicant: DEXERIALS CORPORATION, Tokyo (JP)

(72) Inventor: Masayoshi KANNO, Tochigi (JP)

(73) Assignee: DEXERIALS CORPORATION, Tokyo (JP)

(21) Appl. No.: 15/110,257

(22) PCT Filed: Jan. 7, 2015
(86) PCT No.: PCT/JP2015/050216

§ 371 Date: Jul. 7, 2016

(30) Foreign Application Priority Data
Jan. 10, 2014 (JP) 2014-003750

(51) Int. Cl. H01Q 7/00; H01Q 1/22; G06K 19/07; H04B 5/00

(52) U.S. Cl. CPC H01Q 7/005; H04B 5/0062; H01Q 1/2208; G06K 19/0726

(57) ABSTRACT

An antenna drive unit has: an oscillator capable of controlling an oscillating frequency; an output part for supplying high frequency signal obtained by the oscillator to an antenna resonance circuit; a controller for controlling the oscillating frequency of the oscillator and the antenna resonance frequency of the antenna resonance circuit; and a phase detector for detecting a phase of output current or output impedance of the output part, wherein the oscillating frequency of the oscillator is controlled by the controller according to an operation mode, and also, the resonance frequency of the antenna resonance circuit is controlled by the controller based on the phase of output current or output impedance of the output part detected by the phase detector.

### BACKGROUND OF THE INVENTION

1. Field of the Invention

The present invention relates to a non-contact communication device comprising function to take non-contact communication with external equipment by electromagnetic induction action and to its antenna resonance frequency control method. This application is based upon and chums the benefit of priority from the Japanese Patent Application No. 2014-003750 filed in Japan on Jan. 10, 2014.

2. Description of Related Art

Non-contact communication system utilizing a non-contact IC (Integrated Circuit) card, for example traffic ticket or electronic money, receives transmission signal transmitted from a transmission antenna (resonance circuit) of a reader writer (hereinafter, referred to as R/W) dedicated to the system by electrometric induction action with a reception antenna arranged in the non-contact IC card.

Also, recently, a portable communication device such as mobile communication terminal and else or a near field communication (NFC) system comprising both of function similar to the non-contact IC card (hereinafter, referred to as IC card function) and function similar to the R/W device (hereinafter, referred to as R/W function) has been developed.

In the portable communication device comprising both of IC card function and R/W function or in IC card in the above non-contact communication system, a resonance frequency of IC card function reception antenna) changes according to various factors such as temperature, humidity, ambient environment of peripheral equipment and else. Concretely, the resonance frequency changes, for example, according to the following factors (1)˜(5) and else.
(1) Influence of variation of manufacturing of components of each function part
(2) influence of part replacement or aging Variation of components after shipment
(3) Characteristic deterioration by change of ambient environment such as temperature, humidity and else
(4) Influence of ornament such as seal and else attached to the portable communication device
(5) Influence of external R/W device

It will be difficult to transmit and receive informative stably, if the resonance frequency of the reception antenna deviates.

Therefore, development of technology has been desired in the past for dealing with the deviation of the resonance frequency of the reception antenna, which occurs by the above various factors.

In addition, for the above factor (1), it is possible to deal with it by adjusting a capacitance (capacitor) or an inductance (coil) composing the resonance circuit in a shipping process of the device. However, in this case, the problem occurs that it is necessary to adjust the capacitance or the inductance per the device. Also, for the above factor (1), it is possible to deal with it by using the component with low characteristic variation. However, in this case, the problem occurs that the components will be expensive and cost will increase. In addition, the above factors (4) and (5) are the problems inherent to the portable communication device for performing non-contact communication by electromagnetic coupling, and it is difficult to deal with it in the shipping process,

In addition, not only limited to the portable communication device comprising both IC card function and RAY function, but also for the RAY device, the resonance frequency of transmission antenna varies by the above factors (1) to (3). Therefore, also to the R/W device, the development of technology has been desired to enabling to adjust the deviation of the resonance frequency easily.

The inventors of this case and else are previously proposing the portable communication device comprising both IC card function and R/W function, R/W device, and the method for adjusting the resonance frequency of these devices (for example, refer to Patent Literature 1), which are configured to obtain stable communication characteristic by enabling to adjust the deviation of resonance frequency of the reception antenna and the transmission antenna easily by adjusting the reception resonance frequency based on a detected parameter including information regarding transmission state of an adjusting signal, which is detected, when the adjusting signal for adjusting the reception resonance frequency is transmitted to the reception part in the portable communication device.

### SUMMARY OF THE INVENTION

In the method for adjusting resonance frequency disclosed in patent literature I proposed previously b the inventors of this case and else, it controls a variable capacity of a resonance circuit such that a phase difference of antenna voltage and current will be 0 outputting a signal of 13.56 MHz as an adjusting signal using R/W function of LSI installed in a portable communication device, so it is necessary to draw out a signal line from an antenna for detecting antenna current phase. Therefore, not only it is necessary to add one antenna terminal and one LSI terminal respectively, but also it is necessary to install an external resistance for detection of antenna current phase, so it causes increase of cost. In addition, also from view of electrical characteristic, there are problems that a sharpness of resonance (Q: Quality factor) will be decreased, and that noise such as unnecessary radiation will be increased, by drawing: out the signal line for detection from the resonance circuit.

Further, in the method for adjusting resonance frequency, an adjustment in IC card function will be necessary separately, as it is an adjustment in R/W function,

Here, an object of the present invention is to provide a non-contact communication device and its antenna resonance frequency control method, wherein the n-contact communication device is capable of corresponding to each resonance frequency in an operation mode of IC card function (hereinafter, referred to as IC card mode) and in an operation mode of R/W function (hereinafter, referred to as R/W mode) in NFC system and else, and also, the non-contact communication device is having no problem of increase of noise such as unnecessary radiation or decrease of Q of resonance or increase of cost due to external resistance or addition a antenna terminal and LSI terminal, as a signal line will not be drawn out from the antenna for detecting antenna current phase, considering the conventional actual circumstance as above.

The other object of the present invention and the concrete advantage obtained by the present invention will be clearer from the explanation oldie embodiments described in the following description.

The inventors of this case has found that as a result of earnest research about non-contact communication device comprising function for taking non-contact communication with external equipment by electromagnetic induction action, a matching circuit is designed such that an output impedance of an antenna drive unit connected to an antenna resonance circuit will be a real number, and that the antenna resonance circuit is a serial/parallel resonance circuit in which a capacitor is connected to an antenna coil in series and in parallel, and which is having it plurality of resonance points, and that a transition point (first resonance point) from C component, in which impedance will be low, to L component is used in 11/W mode, and as transition point (second resonance point) from L component, in Which impedance will be high, to C component is used in IC card mode, and that an antenna current maximum frequency in R/W mode are strongly correlated to the first resonance point when Q of resonance circuit is high, and that it is possible to detect a resonance frequency of the antenna resonance circuit as a phase of output current or impedance of the antenna drive unit.

In the present invention, the resonance frequency of the antenna resonance circuit is controlled based on the detection result of a phase of output current or impedance of the antenna drive unit.

Namely, the present invention is a non-contact communication device comprising: an antenna resonance circuit capable of controlling a resonance frequency of an antenna for communicating with other party by electromagnetic coupling; and an antenna drive unit connected to the antenna resonance circuit, wherein the antenna drive unit comprises: an oscillator capable of controlling an oscillating frequency; an output part for supplying high frequency signal obtained by the oscillator to the antenna resonance circuit; a controller for controlling the oscillating frequency of the oscillator and the antenna resonance frequency of the antenna resonance circuit; and as phase detector for detecting a phase of output current or output impedance of the output part, wherein the oscillating frequency of the oscillator is controlled 1w the controller according to the operation mode, and also, the resonance frequency of the antenna resonance circuit is controlled by the controller based on the phase of output current or output impedance of the output part detected by the phase detector

In the non-contact communication device relating to the present invention, the antenna resonance circuit is a serial/parallel resonance circuit, in which a capacitor is connected to an antenna coil in series and in parallel, and the controller is capable of determining the point that the phase of the output current or output impedance of the output pan detected by the phase detector is changed from minus to plus as a first resonance frequency, and the point that the phase of the output current or output impedance of the output part: detected by the phase detector is changed from plus to minus as a second resonance frequency, by controlling the resonance frequency of the antenna resonance circuit.

Also, in the non-contact communication device relating to the present invention, the controller can be configured to control the oscillating frequency of the oscillator in adjustment mode, and to control the antenna resonance circuit to the first resonance frequency in R/W mode, and to control the antenna resonance circuit to the second resonance frequency in IC card mode.

Further, in the non-contact communication device relating to the present invention the controller can be configured to control the resonance frequency of the antenna resonance circuit to a resonance frequency added with an offset amount in anticipation of resonance frequency shift by the antenna of the antenna resonance circuit.

In addition, the present invention is a method for controlling antenna resonance frequency in non-contact communication device comprising an antenna drive unit connected to an antenna resonance circuit capable of controlling the resonance frequency of the antenna for communicating with other party by electromagnetic coupling, wherein the antenna drive unit comprises: an oscillator capable of controlling the oscillating frequency of high frequency signal supplied to the antenna resonance circuit; an output: part for supplying the high frequency signal obtained by the oscillator to the antenna resonance circuit; a controller for controlling the oscillating frequency of the oscillator and the antenna resonance frequency of the antenna resonance circuit; and a phase detector for detecting a phase of output current or output impedance of the output part, wherein the oscillating frequency of the oscillator is controlled by the controller according to the operation mode, and also, the resonance frequency of the antenna resonance circuit is controlled by the controller based on the phase of output current or output impedance of the output part detected by the phase detector.

In the method for controlling antenna resonance frequency relating to the present invention, it can be configured to control the oscillating frequency of the oscillator, and to detect a first resonance frequency of the antenna resonance circuit, in which the phase of output current or output impedance of the output part detected by the phase detector is changed from minus to plus, and a second resonance frequency of the antenna resonance circuit, in which the phase of output current or output impedance of the output part detected by the phase detector is changed from plus to minus, and to store them in a storage means in adjustment mode, and to control the antenna resonance circuit to the first resonance frequency in R/W mode, and to control the antenna resonance circuit to the second resonance frequency in IC card mode,

Also, in the method for controlling antenna resonance frequency relating to the present invention, it can be configured to control the oscillating frequency of the oscillator, and to detect a first resonance frequency of the antenna resonance circuit, in which the phase of output caffeine or output impedance of the output part detected by the phase detector is changed from minus to plus, and a second resonance frequency of the antenna resonance circuit, in which the phase of output current or output impedance of the output part detected by the phase detector is changed from plus to minus, by one frequency scanning and to store them in the storage means in adjustment mode,

In the present invention, the controller of the antenna drive unit controls the oscillating frequency of the oscillator according to the operation mode, and also controls the resonance frequency of the antenna resonance circuit based on the phase of output current or output impedance of the output part detected by the phase detector, so the signal line will not be drawn out from the antenna for detecting antenna current phase, and there is no problem of increase of noise such as unnecessary radiation or decrease of Q of resonance or cost increase due to external resistance or addition of antenna terminal and LSI terminal. Also, it is possible to correspond to each resonance frequency in R/W mode and IC card mode in NFC system and else.

### BRIEF DESCRIPTION OF THE DRAWINGS

FIG. 1 is a circuit diagram illustrating the configuration of non-contact communication device applying the present invention.

FIG. 2A and 2B are circuit diagrams illustrating the structure of basic matching circuit used in non-contact communication like NFC system, and FIG. 2A is illustrating a single drive type circuit structure, and FIG. 2B is illustrating a differential the type circuit structure.

FIG. 3 is a characteristic diagram illustrating the calculation result of impedance characteristic viewed from T×1, T×2 terminals in basic matching circuit of the differential drive type circuit structure.

FIG. 4 is a characteristic diagram illustrating the comparison of antenna current maximum value and impedance Z (θ)=0 and antenna current (θ)=0.

FIG. 5A and 5B are characteristic diagrams illustrating the comparison result of frequency of antenna current maximum value and antenna current (0) 0 and impedance Z (θ)=0 of T×terminal, and FIG. 5A is illustrating the characteristic when antenna resonance circuit is high and is 30 or more, and FIG. 5B is illustrating when Q of antenna resonance circuit is low and is 15.

FIG. 6 is a characteristic diagram illustrating the simulation result of the case that resonance frequency in IC card mode is detected by a pickup coil.

FIG. 7 is a flow chart illustrating the order of processing in adjustment mode (Self tuning mode 1) of R/W mode in the non-contact communication device.

FIG. 8 is a flow chart illustrating the order of processing in adjustment mode (Self toning mode 2) of IC card mode in the non-contact communication device,

### DETAILED DESCRIPTION OF THE INVENTION

Embodiments of the present invention will be described below in detail with reference to the accompanying drawings. Needless to say, the present invention is not limited to embodiments that will be described below, and these embodiments can he modified in various ways without departing from the gist of the present invention.

The present invention is adopted to a non-contact communication device 100 comprising both of R/W function and IC card function corresponding to near field communication INK) system and else, and for example as illustrated in a circuit diagram of Fig, 1, a method fur controlling antenna resonance frequency relating to the present invention is performed by the non-contact communication device 100 comprising a differential drive type antenna resonance circuit 10 capable of controlling antenna resonance frequency for communicating with other party by electromagnetic coupling, and an antenna drive unit 20 connected to the antenna resonance circuit 10,

The antenna resonance circuit i 0 in this non-contact communication device 100 comprises: a serial/parallel resonance circuit 11 in which capacitors C1 to C5, VC1 are connected to an antenna coil L1 in series and in parallel; and a EMC filter 12 composed of coils L2, L3 and capacitors C6, C7, and it is configured to be able to change the antenna resonance frequency by changing control voltage applied to a variable resonance capacitor VC1. As the variable resonance capacitor VC1, a variable capacitance capacitor, in which capacitance will be decreased when control voltage to he applied will be increased, is used and its one control end is installed via a bias resistance R1, and the other control end is connected to a control terminal via a bias resistance R2.

Also, the antenna drive unit 20 in this non-contact communication device 100 comprises: an oscillator 21 capable of controlling an oscillating frequency; an output part 22 for supplying high frequency signal obtained by the oscillator 21 to the antenna resonance circuit 10; a controller 23 for controlling the oscillating frequency of the oscillator 21 and the antenna resonance frequency of the antenna resonance circuit 10; a phase detector 24 for detecting the phase of output current or output impedance of the output pan 22, a digital/analog convener 25 connected to the controller 23; and storage unit 26.

The oscillator 21 is composed of a frequency variable oscillator capable of controlling the oscillating frequency over wide range, for example from 12 to 17 MHz, by frequency control signal supplied from the controller 23.

Also, the output part 22 is composed of a pair of differential amplifier 22A, 22B for outputting a high frequency signal supplied from the oscillator 21 as a positive phase high frequency signal and a negative phase high frequency signal.

Also, the phase detector 24 is connected to an input end and an output end of differential amplifier 22A of the output part 22, and it detects the phase of output current and output impedance of the differential amplifier 22A from impedance of the differential amplifier 22A itself and a difference between a voltage V1 of high frequency signal inputted to the differential amplifier 22A and a voltage V2 of positive phase high frequency signal outputted from the differential amplifier 22A, and supplies its detection result to the controller 23.

Also, the controller 23 is to control R/W function and IC card function of the non-contact communication device 100, and R/W is composed for example CPU (Central Processing Unit), and it outputs frequency control signal for controlling the oscillating frequency of the oscillator 21 according to an operation mode, and also, it outputs control voltage signal for controlling the resonance frequency of the antenna resonance circuit 10 based on the phase of output current and output impedance of the output part 22 detected by the phase detector 24,

And, the digital/analog convener 25 connected to the controller 23 converts digital control voltage signal outputted from the controller 23 into analog control voltage signal cont, and it is configured to he applied to the variable resonance capacitor VC1 via a control terminal of the antenna resonance circuit 10.

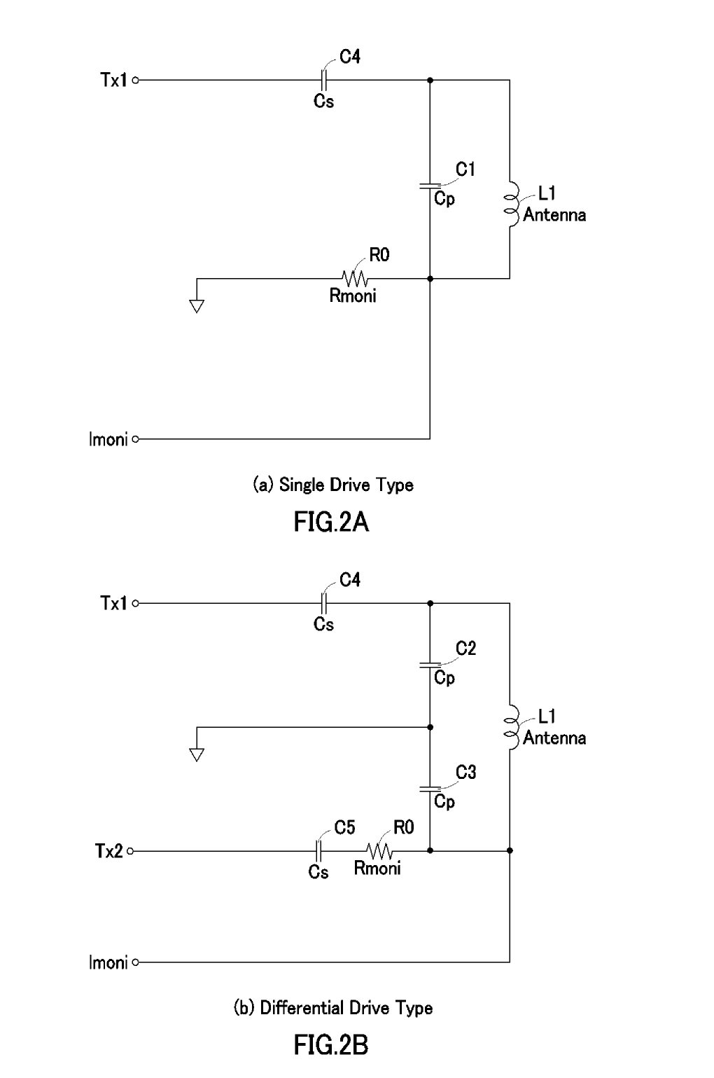

Here, as a basic matching circuit used in non-contact communication such as NFC system, there are a single drive type circuit structure, which drives an antenna L1 with 1 channel illustrated in FIG. 2B, and a differential drive type circuit structure, which drives an antenna L1 with 2 channels illustrated in FIG. 2B, and its basic operation is same in both circuit structures. T×1 terminal and T×2 terminal will be drive terminals of the antenna drive unit.

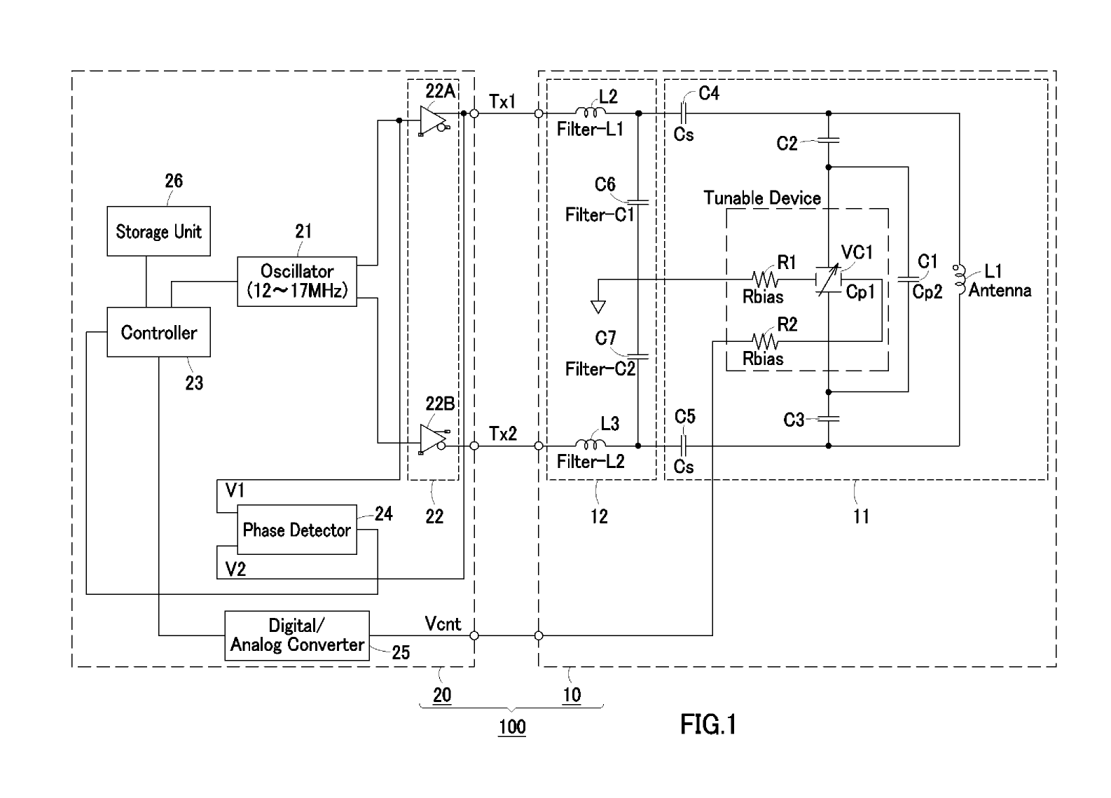

The components corresponding to the components of the antenna resonance circuit 10 illustrated in FIG. 1 are illustrated with identical reference number in FIGS. 2A and 2B.

The antenna resonance circuit 10 in the non-contact communication device 100 is composed of a differential drive type circuit structure, which drives an antenna L1 with 2 channels.

And, the antenna resonance circuit 10 comprises serial/parallel resonance circuit 11 in which capacitors C1 to C5. VC1 are connected to an antenna coil L1 in series and in parallel, in order to transmit and receive signal of 13.56 MHz efficiently,

In R/W mode, the controller 23 controls to oscillate the oscillator 21 in 13.56 MHz, and to output positive phase high frequency minamal and negative Phase high frequency signal of 13.56 MHz from the output part 22 to T×1 terminal and T×2 terminal.

In IC card mode, the controller 23 controls to detect a reception signal induced by the antenna L1 of the antenna resonance circuit 10 by a reception circuit not illustrated in drawings, and to respond by load modulation.

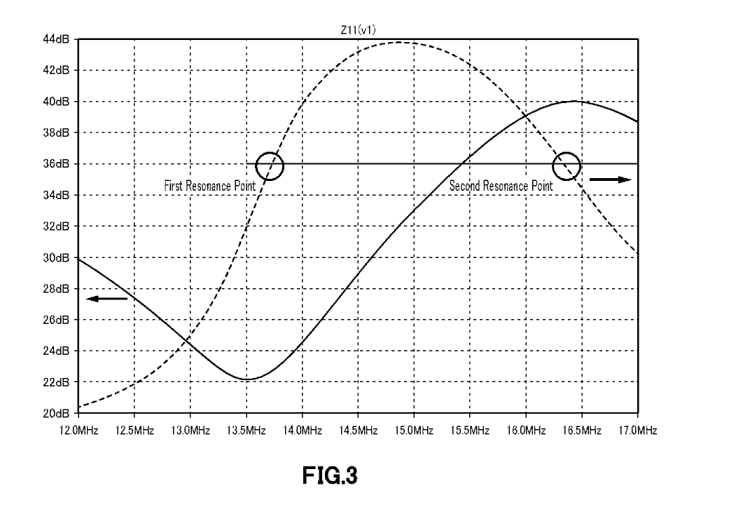

The calculation result of impedance characteristic viewed front T×1 terminal and T×2 terminal in basic matching circuit of differential dine type circuit structure illustrated in FIG. 2B is illustrated in FIG. 3.

In FIG. 3, a solid line illustrates impedance Z, and a dotted line illustrates phase θ, and the point that will be θ=0 is resonance point.

When frequency is low, capacity C3 of capacitors C4 and C5 serial to antenna coil L1 is dominant and impedance Z decreases and phase θ indicates minus, but as the frequency gets higher, effect of inductance of antenna coil L1 increases, and impedance Z increases, and phase 0 turns to plus. This first resonance point is possible to now large current to antenna coil L1 as resistance decreases, so it is used as R/W mode.

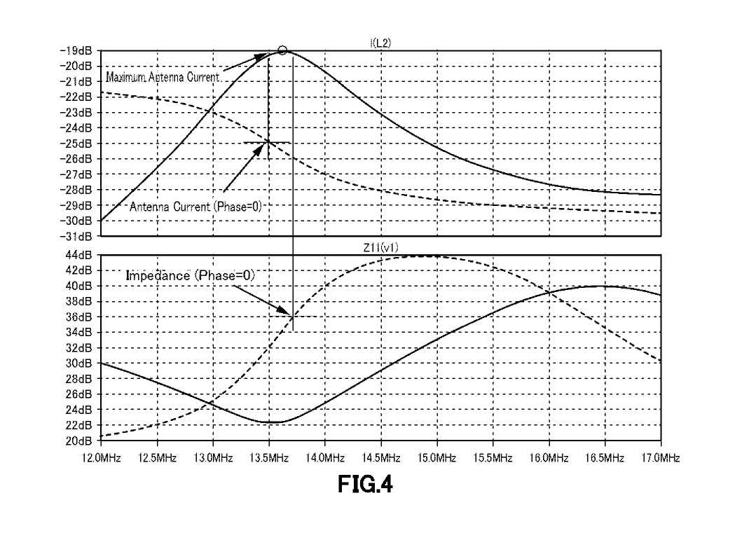

As antenna current maximum value, impedance Z (θ)=0, and antenna current) (θ)=0 are illustrated in comparison in FIG. 4, the antenna maximum value indicates a value near impedance Z (θ)=0 and antenna current (θ)=0, but deviates little from them. In other words, a resonance antenna will be a circuit comprising serial capacitors C4 and C5 or EMC filter for noise elimination, so it will not always coincide with impedance Z (θ)=0 and antenna current (θ)=0 of parallel resonance circuit composed of antenna coil L1 of capacitors C1 and C3. However, impedance Z (θ) is detected including peripheral circuit part such as serial resonance capacitor or EMC filter, so its value is nearer to antenna current maximum value than antenna current (θ)=0.

Impedance Z (0) can be calculated with Z=V/I by measuring current I and terminal voltage V of T×1 terminal and T×2 terminal, and if the terminal voltage V is constant, phase θ of impedance Z coincides with phase 0 of current I, so it is possible to detect resonance point by detecting current phase of T× terminal.

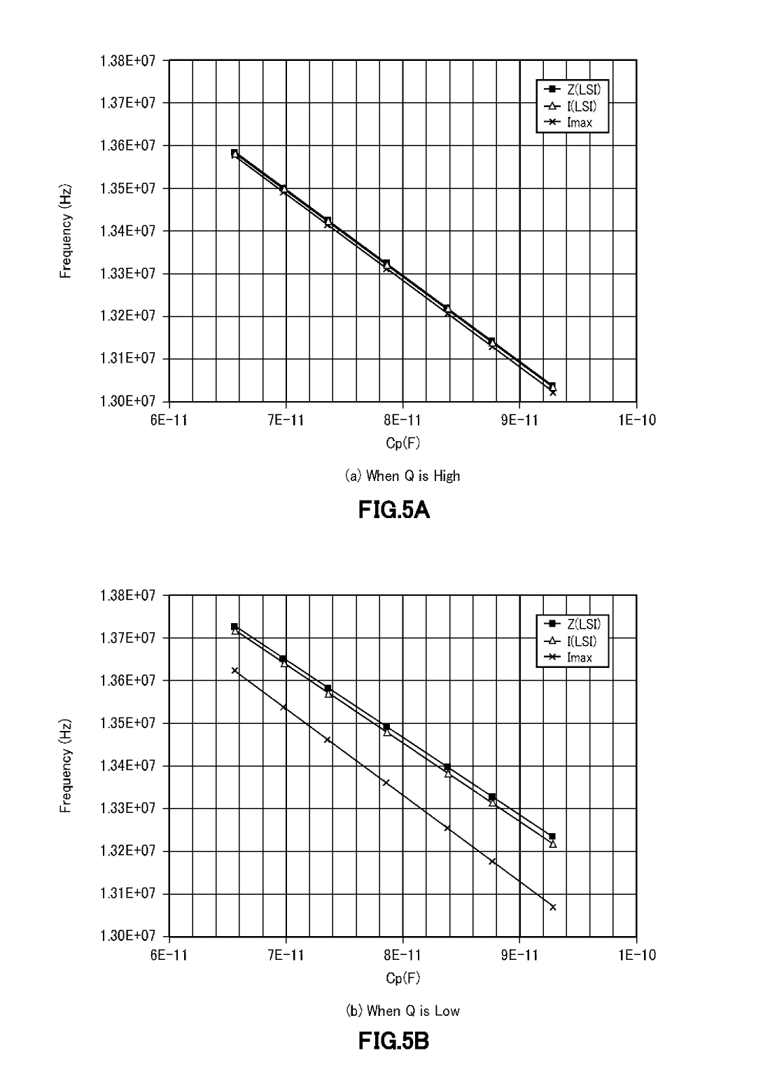

The comparison result of frequency of antenna current maximum value and antenna current (θ)=0 and impedance Z (θ)=0 of T× terminal is illustrated in FIGS. 5A and 5B, FIG. 5A, is illustrating the characteristic when Q of antenna resonance circuit is high and is 30 or more and FIG. 5B is illustrating when Q of antenna resonance circuit is low and is 15. As illustrated in FIGS. 5A and 5B, when Q of antenna resonance circuit is high and is 30 or more, the frequency of antenna current maximum value and current I (θ)=0 and impedance Z (θ)=0 coincides well, but when Q of antenna resonance circuit is low and is 15, the difference with antenna current is large.

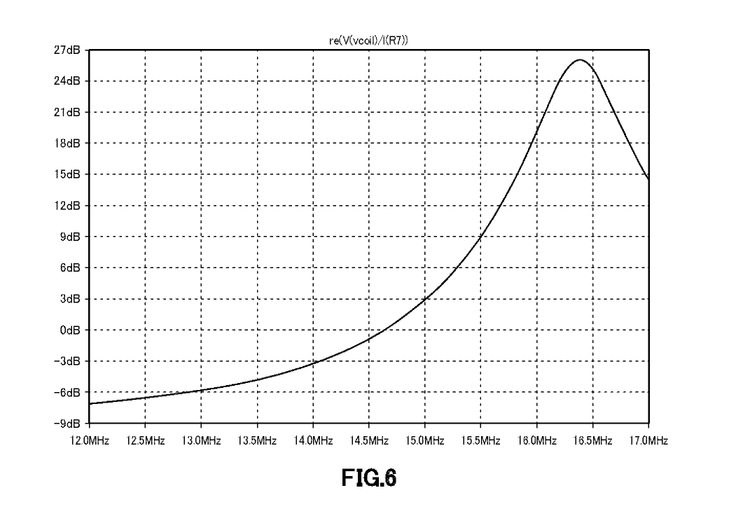

Also, the simulation result of the case that resonance frequency in IC card mode is detected by a pickup coil is illustrated in FIG. 6. The vertical aids in FIG. 6 is impedance, in IC card mode, the impedance is increased using parallel resonance for inducing large voltage with small current, and impedance maximum value will be resonance frequency. The resonance frequency in this IC card mode coincides with second resonance point in FIG. 3, and it differs from first resonance point in the point that it is a transition point of impedance Z (0) from plus to minus,

The first resonance point and the second resonance point can be distinguished by a changing manner of phase θ of impedance Z.

In the non-contact communication device 100, the controller 23 sets oscillating frequency of the oscillator 21 to 13.56 MHz when performing adjustment mode of R/W mode, and increases analog control voltage signal Vcont applied from the digitalianalog converter 25 to the variable resonance capacitor VC1 via a control terminal of the antenna resonance circuit 10 until 0 phase is detected by the phase detector 24, and the applied voltage when 0 phase is detected is stared in storage unit. 26 as colitrol voltage of first resonance point.

In addition, the detection oft) phase in the phase detector 24 can be performed b phase detection, but it is possible to simplify the detection circuit by detecting the point when the phase turns plus from minus.

Also, in the non-contact communication device 100, the controller 23 sets oscillating frequency of the oscillator 21 to 16.0 MHz when perforating, adjustment mode of IC card mode, and increases analog control voltage signal Vcont applied from the digital/analog converter 25 to the variable resonance capacitor VC1 via a control terminal of the antenna resonance circuit 10 until θ phase is detected by the phase detector 24, and the applied Voltage when the point that the phase of output current or output impedance of the output part changes from plus to minus is detected is stored in storage unit 26 as control voltage of second resonance point.

In adjustment mode, the controller 23 controls the oscillating frequency of the oscillator 21., and detects resonance frequency at the first resonance point and resonance frequency at second resonance point in the antenna resonance circuit 10, and stores each control voltage in the storage unit 26, and in R/W mode, it can control the antenna. resonance circuit 10 to the first resonance frequency, and in IC card mode, it can control the antenna resonance circuit 10 to the second resonance frequency,

In the non-contact communication device too, the oscillating frequency of the oscillator 21 is controlled by the controller 23 according to the operation mode., and also, the resonance frequency of the antenna resonance circuit 10 is controlled by the controller 23 based on the phase of output current or output impedance of the output part 22 detected b the phase detector 24, so there is no need for monitor resistance RI or antenna current phase detection terminal Imoni in basic matching circuit illustrated in FIGS. 2A and 2B.

Here, when performing adjustment mode of R/W mode, the controller 23 can provide offset to a set frequency considering a deviation between antenna current maximum value and impedance Z (θ)=0. The amount of this offset depends on the antenna characteristic, so an equipment manufacturer could set and store it in the storage unit 26,

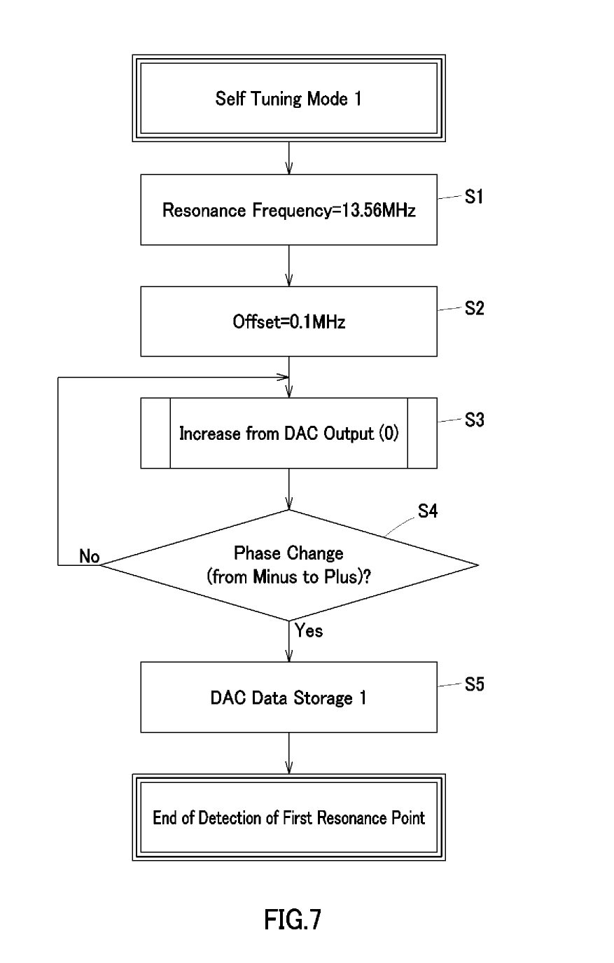

Then, the concrete order of processing at adjustment mode (Self tuning mode 1 of R/W mode in the non-contact communication device 100 is illustrated in a flow chart of FIG. 7.

When shifted to Self tuning mode 1, the controller 23 of the non-contact communication device 100 reads out offset value and adjustment resonance frequency stored in the storage unit 26 at first and sets it to the oscillator 21 (step S1, S2), In this example, 13.56 MHz is set to the oscillator 21 as adjustment resonance frequency of R/W mode in step S1, and in step S2, 0.1 MHz is set to the oscillator 21 as offset amount caused by the resonance antenna.

Thereby, the oscillator 21 oscillates in 13.66 MHz, in which offset amount of 0.1 MHz is added to 13.56 MHz.

Then, the controller 23 increases analog control voltage signal Vcont applied from the digital/analog convener 25 to the variable resonance capacitor VC1 via a control terminal of the antenna resonance circuit 10 per unit voltage from 0 V per one step (step S3), and determine whether the phase detected by the phase detector 24 changes from minus to plus or not (step S4).

When the determination result in the step S4 is “No”, in other words., when the phase detected by the phase detector 24 is not changed from minus to plus the controller 23 repeatedly performs the control to go back to the step S3 and to increase the analog control voltage signal Vcont per unit voltage from 0 V per one step and to sequentially increase the resonance frequency of the antenna resonance circuit 10,

And, the controller 23 repeatedly performs the process of the step S3 and the step 84 until the determination result in the step S4 becomes “Yes”, in other words, until the phase detected by the phase detector 24 changes from minus to plus, and when the determination result in the step S4 is “Yes”, in other words, when the phase detected by the phase detector 24 is changed from minus to plus, it stores the number of steps to have increased the analog control voltage signal Vcont outputted from the digitalianalog convener 25 per unit voltage from 0 V per one step in the storage unit 26 as an optimum adjusted value (step S5), and ends the detection process of the first resonance point by Self tuning mode 1.

The number of steps stored in the storage unit 26 is a point that the phase detected b the phase detector 24 is changed from minus to plus, in other words, it is the optimum adjusted value of applied voltage of the variable resonance capacitor VC1 corresponding to the first resonance point of the antenna resonance circuit 10.

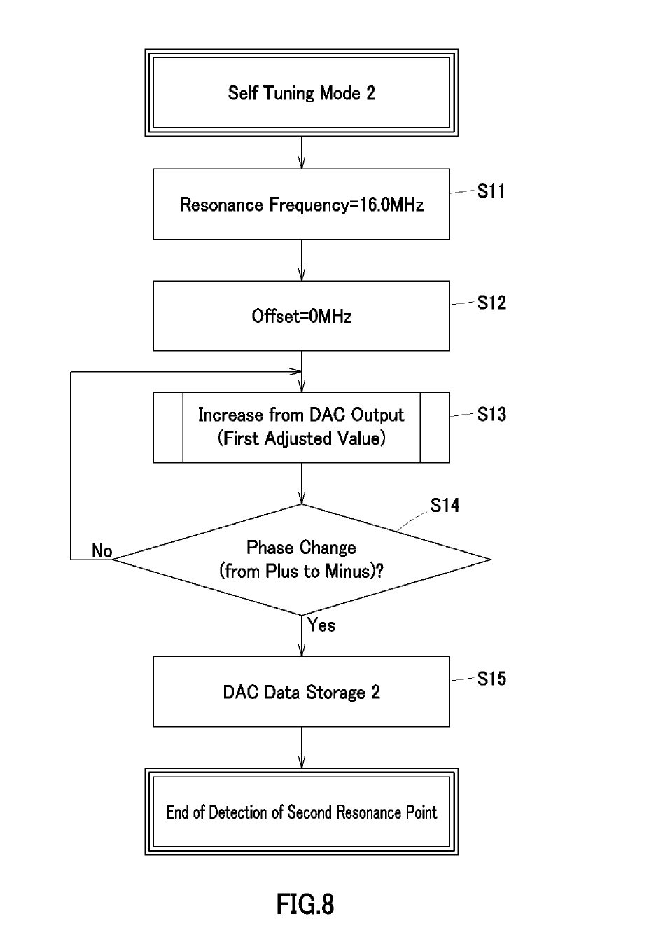

Also, the concrete miler of processing at adjustment mode (Self tuning mode 2) of IC card mode in the non contact communication device 100 is illustrated in a flow chart of FIG. 8.

When shifted to Self tuning mode 2, the controller 23 of the non-contact communication device Inn reads out offset value and adjustment resonance frequency stored in the storage unit 26 a first and sets it to the oscillator 21 (step S11, S12), in this example, 16.0 MHz is set to the oscillator 21 as adjustment resonance frequency of IC card mode in step S11, and in step S12, 0 MH is set to the oscillator 21 as offset amount caused by the resonance antenna.

Thereby, the oscillator 21 oscillates in 16.0 MHz.

Then, the controller 23 increases analog control voltage signal Vcont applied from the digital/analog converter 25 to the variable resonance capacitor VC1 via a control terminal of the antenna resonance circuit 10 per unit voltage from first adjusted value per one step (step S13), and determine whether the phase detected by the phase detector 24 changes from plus to minus or not (step S14).

When the determination result in the step S14 is “No”, in other words , when the phase detected by the phase detector 24 not changed from plus to minus, the controller 23 repeatedly performs the control to go back to the step S13 and to increase the analog control voltage signal wont per unit Voltage from first adjusted value per one step and to sequentially increase the resonance frequency of the antenna resonance circuit 10.

And the controller 23 repeatedly performs the process of the step S13 and the step S14 until the determination result in the step S14 becomes “Yes”, in other words, until the phase detected by the phase detector 34 changes from plus to minus, and then the determination result in the step S14 is “Yes”, in other words, when the phase detected by the fast detector 24 is changed from plus to minus, it stores the number of steps to have increased the analog control voltage signal Vcont outputted from the digital/analog converter 25 per unit voltage from first adjusted value per one step in the storage unit 26 as app optimum adjusted value (step S15), and ends the detection process of the second resonance point by self tuning mode 2. The number of steps stored in the storage unit 26 is a point that the phase detected by the phase detector 24 is changed from plus to minus, in other words, it is the optimum adjusted value of applied voltage of the variable resonance capacitor VC1 corresponding to the second resonance point, of the antenna resonance circuit 10.

In the flow of detection process of the second resonance point by Self tuning mode 2, the analog control voltage signal wont is increased per unit voltage from the first adjusted value per one step in step S14, and not from 0 V as step 4 in the flow of detection process of the first resonance point b Self tuning mode 1, so it is possible to shorten the adjustment time by setting the first adjusted value to the optimum value.

Here, in step S14, the flow of detection process of the second resonance point by Self tuning mode 2 is identical with the flow of detection process of the first resonance point by Self tuning mode 1, except that it performs a process for detection the point in which the phase detected by the phase detector 24 changes from plus to minus.

As such in the non-contact communication device 100 comprising both of R/W function and IC card function corresponding to near field communication (NFC) system and else, the detection process of the first resonance point by adjustment mode (Self tuning mode 1) of R/W mode and the detection process of the second resonance point by adjustment mode (Self tuning mode 2) of IC card mode can be performed by the same manner, so it is possible to achieve Self tuning easily by communication LSI.

Also, it is explained that the detection process of the first resonance point is performed by adjustment mode (Self tuning mode 1) of R/W mode and the detection process of the second resonance point is performed by instrument mode (Self tuning mode 2) of IC card mode, but in the non-contact communication des ice 100, it is possible to control oscillating frequency of the oscillator 21 by the controller 23, and to detect the first resonance frequency of the antenna resonance circuit 10, in which the phase of output current or output impedance of the output part 22 detected by the phase detector 24 changes from minus to plus, and the second resonance frequency of the antenna resonance circuit 10, in which the phase of output current or output impedance of the output part 22 detected by the phase detector 24 changes from plus to minus, with one frequency scanning, and to store them in the storage unit 26, in adjustment mode of R/W mode.

As explained above, m the non-contact communication device 100, the oscillating frequency of the oscillator 21 is controlled by the controller 23 according to the operation mode, and also the resonance frequency of the antenna resonance circuit 111 is controlled b the controller 2 based on the phase of output current or output impedance of the output part 22 detected by the phase detector 24, so the signal hue will not be drawn out from the antenna for detecting antenna current phase, and there is no problem of increase of noise such as unnecessary radiation or decrease of Q of resonance or cost increase due to external resistance or addition of antenna terminal and LS1 terminal, Also, it is possible to correspond to each resonance frequency in R/W mode and IC card mode in NFC system and else.

### GLOSSARY OF DRAWING REFERENCES

10 Antenna Resonance Circuit
11 Serial /Parallel Resonance Circuit
20 Antenna Drive Unit
21 Oscillator
22 Output Part
27A, 22B Differential Amplifier
23 Controller
24 Phase Detector
25 DigitallAnalog Converter
26 Storage Unit
100 Non-contact Communication Device
L1 Antenna Coil
C1 to C7 Capacitor
VC1 Variable Resonance Capacitor
L2, L3 Coil
12 EMC Filter
R1, R2 Bias Resistance

1. A non-contact communication device comprising:
an antenna resonance circuit capable of controlling a resonance frequency of an antenna for communicating with other party by electromagnetic coupling; and
an antenna drive unit connected to the antenna resonance circuit,
wherein the antenna drive unit comprises: an oscillator capable of controlling an oscillating frequency; an output part for supplying high frequency signal obtained by the oscillator to the antenna resonance circuit; a controller for controlling the oscillating frequency of the oscillator and the antenna resonance frequency of the antenna resonance circuit; and a phase detector for detecting a phase of output current or output impedance of the output part,
wherein the oscillating frequency of the oscillator is controlled by the controller according to an operation mode, and also, the resonance frequency of the antenna resonance circuit is controlled by the controller based on the phase of output current or output impedance of the output pan detected b the phase detector.

2. The non-contact communication device according to claim 1, wherein the antenna resonance circuit is a serial/parallel resonance circuit, in which a capacitor is connected to an antenna coil in series and in parallel, and
wherein the controller is capable of determining the point that the phase of output current or output impedance of the output pan detected by the phase detector is changed from minus to plus as a first resonance frequency, and the point that the phase of the output current or output impedance of the output part detected by the phase detector is changed from plus to minus as a second resonance frequency, by controlling the resonance frequency of the antenna resonance circuit.

3. The non-contact communication device according to claim 2, wherein the controller detects the first resonance frequency of the antenna resonance circuit, in which the phase of output current or output impedance of the output part detected by the phase detector is changed from minus to plus, and the second resonance frequency of the antenna resonance circuit, to which the phase of the output current or output impedance of the output part detected by the phase detector is changed from plus to minus, and stores them in a storage means in adjustment mode, and controls the resonance frequency of the antenna resonance circuit to the first resonance frequency in R/W mode, and controls the resonance frequency of the antenna resonance circuit to the second resonance frequency in IC card mode.

4. The non-contact communication device according to claim 1, wherein the controller controls the resonance frequency of the antenna resonance circuit to a resonance frequency added with an offset amount in anticipation of resonance frequency shift by an antenna of the antenna resonance circuit.

5. A method for controlling antenna resonance frequency in non-contact communication device comprising an antenna drive unit connected to an antenna resonance circuit capable of controlling the resonance frequency of the antenna for communicating with other party by electromagnetic coupling, wherein the antenna drive unit comprises: an oscillator capable of controlling the oscillating frequency of high frequency signal supplied to the antenna resonance circuit, an output part for supplying the high frequency signal obtained by the oscillator to the antenna resonance circuit: a controller for controlling the oscillating frequency of the oscillator and the antenna resonance frequency of the antenna resonance circuit; and a phase detector for detecting a phase of output current or output impedance of the output part,
wherein the oscillating frequency of the oscillator is controlled by the controller according to the operation mode, arid also, the resonance frequency of the antenna resonance circuit is controlled by the controller based on the phase of output current or output impedance of the output part detected by the phase detector.

6. A method for controlling antenna resonance frequency according to claim 5, comprising:
detecting a first resonance frequency of the antenna resonance circuit, in which the phase of output current or output impedance of the output part detected by the phase detector is changed from minus to plus, and a second resonance frequency of the antenna resonance circuit, in which the phase of output current or output impedance of the output part detected b the phase detector is changed from plus to minus, and storing them in a storage means in adjustment mode;
controlling the antenna resonance circuit to the first resonance frequency in R/W mode; and
controlling the antenna resonance circuit to the second resonance frequency in IC card mode.

7. A method for controlling antenna resonance frequency according to claim 6, comprising_{:}
controlling the oscillating frequency of the oscillator and detecting a first resonance frequency of the antenna resonance circuit, in which the phase of output current or output impedance of the output part detected by the phase detector is changed from minus to plus, and a second resonance frequency of the antenna resonance circuit, in which the phase of output current or output impedance of the output part detected by the phase detector is changed from plus to minus, by one frequency scanning, and storing them in the storage means in adjustment mode.
